(19) United States
(12) Patent Application Publication
(10) Pub. No.: US 2025/0287052 A1
(43) Pub. Date: Sep. 11, 2025

(54) Content System with Aspect Ratio-Related Supplemental Video Content Feature

(71) Applicant: Roku, Inc., San Jose, CA (US)

(72) Inventors: Paul Nangeroni, San Carlos, CA (US); Abhay Ujwal Bhorkar, Cupertino, CA (US)

(21) Appl. No.: 18/600,895

(22) Filed: Mar. 11, 2024

(51) Int. Cl. H04N 21/2343; H04N 21/235; H04N 21/2662

(52) U.S. Cl. CPC H04N 21/234372; H04N 21/235; H04N 21/2662

(57) ABSTRACT

In one aspect, an example method includes: (i) determining an aspect ratio of video content; (ii) determining a target aspect ratio, wherein the target aspect ratio is different from the aspect ratio of the video content; determining an aspect ratio and position of at least one empty video content region that results from inserting the video content having the aspect ratio into a frame having the target aspect ratio; (iii) using at least a portion of the video content to generate corresponding supplemental video content that is suitable for insertion into the at least one empty video content region; and (v) performing one or more actions to facilitate a content-presentation device displaying in a display area having the target aspect ratio, both the video content and the supplemental video content, wherein the displaying involves positioning the generated supplemental video content within the at least one empty video content region.

### USAGE AND TERMINOLOGY

In this disclosure, unless otherwise specified and/or unless the particular context clearly dictates otherwise, the terms “a” or “an” mean at least one, and the term “the” means the at least one.

### SUMMARY

In one aspect, an example method is disclosed. The method includes: (i) determining an aspect ratio of video content; (ii) determining a target aspect ratio, wherein the target aspect ratio is different from the aspect ratio of the video content; (iii) determining an aspect ratio and position of at least one empty video content region that results from inserting the video content having the aspect ratio into a frame having the target aspect ratio, wherein the inserting involves centering the video content within the frame; (iv) using at least a portion of the video content to generate corresponding supplemental video content that is suitable for insertion into the at least one empty video content region having the corresponding determined aspect ratio and position; and (v) performing one or more actions to facilitate a content-presentation device displaying in a display area having the target aspect ratio, both the video content and the supplemental video content, wherein the displaying involves (a) centering the video content within the display area, and (b) positioning the generated supplemental video content within the at least one empty video content region that results from displaying the video content having the aspect ratio within the display area having the target aspect ratio.

In another aspect, an example computing system is disclosed. The computing system is configured for performing a set of acts that includes: (i) determining an aspect ratio of video content; (ii) determining a target aspect ratio, wherein the target aspect ratio is different from the aspect ratio of the video content; (iii) determining an aspect ratio and position of at least one empty video content region that results from inserting the video content having the aspect ratio into a frame having the target aspect ratio, wherein the inserting involves centering the video content within the frame; (iv) using at least a portion of the video content to generate corresponding supplemental video content that is suitable for insertion into the at least one empty video content region having the corresponding determined aspect ratio and position; and (v) performing one or more actions to facilitate a content-presentation device displaying in a display area having the target aspect ratio, both the video content and the supplemental video content, wherein the displaying involves (a) centering the video content within the display area, and (b) positioning the generated supplemental video content within the at least one empty video content region that results from displaying the video content having the aspect ratio within the display area having the target aspect ratio.

In another aspect, an example non-transitory computer-readable medium is disclosed. The computer-readable medium has stored thereon program instructions that upon execution by a computing system, cause performance of a set of acts that includes: (i) determining an aspect ratio of video content; (ii) determining a target aspect ratio, wherein the target aspect ratio is different from the aspect ratio of the video content; (iii) determining an aspect ratio and position of at least one empty video content region that results from inserting the video content having the aspect ratio into a frame having the target aspect ratio, wherein the inserting involves centering the video content within the frame; (iv) using at least a portion of the video content to generate corresponding supplemental video content that is suitable for insertion into the at least one empty video content region having the corresponding determined aspect ratio and position; and (v) performing one or more actions to facilitate a content-presentation device displaying in a display area having the target aspect ratio, both the video content and the supplemental video content, wherein the displaying involves (a) centering the video content within the display area, and (b) positioning the generated supplemental video content within the at least one empty video content region that results from displaying the video content having the aspect ratio within the display area having the target aspect ratio.

### BRIEF DESCRIPTION OF THE DRAWINGS

FIG. 1 is a simplified block diagram of an example content system in which various described principles can be implemented.

FIG. 2 is a simplified block diagram of an example computing system in which various described principles can be implemented.

FIG. 3 is an example depiction of video content within a frame.

FIG. 4 is another example depiction of video content within a frame.

FIG. 5 is an example depiction of video content and corresponding generated supplemental video content.

FIG. 6 is another example depiction of video content and corresponding generated supplemental video content.

FIG. 7 is an example depiction of composite video content displayed in a display area of a content-presentation device.

FIG. 8 is another example depiction of composite video content displayed in a display area of a content-presentation device.

FIG. 9 is a front view of an example television including multiple video content projectors.

FIG. 10 is a flow chart of an example method.

FIG. 11 is a flow chart of another example method.

FIG. 12 is a flow chart of another example method.

FIG. 13 is a flow chart of another example method.

### DETAILED DESCRIPTION

### I. Overview

Video content can have various attributes, an example of which is an aspect ratio, which is the ratio of the video content's width to its height. Video content is usually expressed with two numbers separated by a colon—that is, in the format x:y. As such, for an x:y aspect ratio, the video content is x units wide and y units high. Generally, each frame of video content has the same aspect ratio, and as such the video content usually has a single aspect ratio that applies to all of the video content. However, in some situations, different portions of the video content (e.g., different frames or segments) can have different aspect ratios.

One common example of a video content aspect ratio is 4:3, meaning that the video content is 4 units wide and 3 units high. This could also be expressed in alternate ways as well, such as 1.333 (repeating):1. In the context of video content, a 4:3 aspect ratio is sometimes referred to as a “full screen” aspect ratio. Video content with a given aspect ratio can have various different resolutions, provided that each resolution adheres to the aspect ratio. For example, video content with a 4:3 aspect ratio can have a resolution of 640×480 (meaning the video content has 640 rows of pixels and 480 columns of pixels), or a resolution of 800×600 (meaning the video content has 800 rows of pixels and 600 columns of pixels), among numerous other possibilities.

Another common example of a video content aspect ratio is 16:9, meaning that the video content is 16 units wide and 9 units high. This could also be expressed in other ways, such as 1.777 (repeating):1. In the context of video content, a 16:9 aspect ratio is sometimes referred to as a “widescreen” aspect ratio. As noted above, video content with a given aspect ratio can have various different resolutions, provided that each resolution adheres to the aspect ratio. For example, video content with a 16:9 aspect ratio can have a resolution of 1,280×720 (meaning the video content has 1,280 rows of pixels and 720 columns of pixels), or a resolution of 1,920×1,080 (meaning the video content has 1,920 rows of pixels and 1,080 columns of pixels), among numerous other possibilities.

In the same way that video content can have an aspect ratio, a display area of a content-presentation device (e.g., a television) can also have an aspect ratio. As such, a display area can have an aspect ratio of 4:3, 16:9, or some other ratio. In the context of video content being displayed in a display area, in the case where the video content and the display area have the same aspect ratio, the video content can fill the entire display area. However, in the case where these aspect ratios are different, the video content (either at its original resolution or at a scaled down resolution, with the aspect ratio being retained) can fill only a portion of the display area, leaving one or more empty video content regions on the display area.

For example, in the case where the video content has a 4:3 aspect ratio and the display area has a 16:9 aspect ratio, the content-presentation device can center the video content within the display area, which therefore results in there being two vertical-side-longer rectangular empty video content regions, each positioned at an opposite horizontal end of the display area. These regions are sometimes referred to as “black bars.” In some instances, a user may find these black bars undesirable as it can leave the user feeling that something is missing or that some of the display area is being wasted. As such, these black bars can potentially create an undesirable user experience.

As one approach to addressing this situation, the content-presentation device can provide one or more display-related settings that the user can select. For example, the content-presentation device can offer a stretch mode that, in the example above where black bars appear on the left and right sides of the display area, horizontally stretches the video content so as to fill some or possibly all of the black bar areas. However, although this can address some user concerns, such as those noted above, it might then create other issues instead. Indeed, stretching video content can distort the video content in a way that may be jarring, and as such, this too can make for an undesirable user experience.

Disclosed herein are systems and corresponding methods that provide alternative approaches that help address these and other issues. According to one aspect of the disclosure, a content manager can (i) determine an aspect ratio of video content; (ii) determine a target aspect ratio, wherein the target aspect ratio is different from the aspect ratio of the video content; (iii) determine an aspect ratio and position of at least one empty video content region that results from inserting the video content having the aspect ratio into a frame having the target aspect ratio, wherein the inserting involves centering the video content within the frame; (iv) use at least a portion of the video content to generate corresponding supplemental video content that is suitable for insertion into the at least one empty video content region having the corresponding determined aspect ratio and position; and (v) performing one or more actions to facilitate a content-presentation device displaying in a display area having the target aspect ratio, both the video content and the supplemental video content, wherein the displaying involves (a) centering the video content within the display area, and (b) positioning the generated supplemental video content within the at least one empty video content region that results from displaying the video content having the aspect ratio within the display area having the target aspect ratio.

As such, by applying this technique, the at least one empty video content regions (i.e., the black bar areas) can be filled with supplemental video content that is contextually relevant to and has been generated specifically for the purpose of being displayed next to the original video content, such that the resulting combination of video content and supplemental content appears to be original video content having the aspect ratio of the display area, and without the jarring effect noted above in connection with the stretching approach. This feature, along with other related features, and corresponding example architecture and example operations, will now be described in greater detail.

### II. Example Architecture

### A. Content System

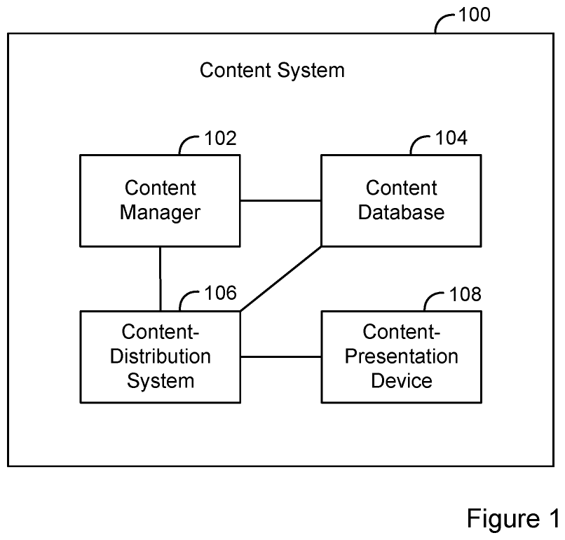

FIG. 1 is a simplified block diagram of an example content system 100. Generally, the content system 100 can perform operations related to various types of content, such as media content, which can take the form of video content and/or audio content. As such, the media content can include a video content component and/or an audio content component. There can be various types of media content. For example, media content can be, or include, a movie, a television show, a commercial or other advertisement content, or a portion or combination thereof, among numerous other possibilities.

Media content can be represented by media data, which can be generated, stored, and/or organized in various ways and according to various formats and/or protocols, using any related techniques now known or later discovered. For example, the media content can be generated by using a camera, a microphone, and/or other equipment to capture or record a live-action event. In another example, the media content can be synthetically generated, such as by using any related media content generation technique now known or later discovered.

As noted above, media data can also be stored and/or organized in various ways. For example, the media data can be stored and organized as a Multimedia Database Management System (MDMS) and/or in various digital file formats, such as the Moving Picture Experts Group 4 (MPEG-4) format, among numerous other possibilities.

The media data can represent the media content by specifying various properties of the media content, such as video properties (e.g., luminance, brightness, and/or chrominance values), audio properties, and/or derivatives thereof. In some instances, the media data can be used to generate the represented media content. But in other instances, the media data can be a fingerprint or signature of the media content, which represents the media content and/or certain characteristics of the media content, and which can be used for various purposes (e.g., to identify the media content or characteristics thereof), but is not sufficient at least on its own to generate the represented media content.

In some instances, media content can include metadata associated with the video and/or audio content. In the case where the media content includes video content and audio content, the audio content is generally intended to be presented in sync with the video content. To help facilitate this, the media data can include metadata that associates portions of the video content with corresponding portions of the audio content. For example, the metadata can associate a given frame or frames of video content with a corresponding portion of audio content. In some cases, audio content can be organized into one or more different channels or tracks, each of which can be selectively turned on or off, or otherwise controlled. There can also be other types of metadata, such as metadata related to an aspect ratio or resolution of video content, or other metadata, such as those types described throughout this disclosure.

In some instances, media content can be made up of one or more segments. For example, in the case where the media content is a movie, the media content may be made up of multiple segments, each representing a scene (or perhaps multiple scenes) of the movie. As another example, in the case where the media content is a television show, the media content may be made up of multiple segments, each representing a different act (or perhaps multiple acts) of the show. In various examples, a segment can be a smaller or larger portion of the media content. For instance, a segment can be a portion of one scene, or a portion of one act. In another example, a segment can be multiple scenes or multiple acts, or various portions thereof.

Returning back to the content system 100, this can include various components, such as a content manager 102, a content database 104, a content-distribution system 106, and a content-presentation device 108. The content system 100 can also include one or more connection mechanisms that connect various components within the content system 100. For example, the content system 100 can include the connection mechanisms represented by lines connecting components of the content system 100, as shown in FIG. 1.

In this disclosure, the term “connection mechanism” means a mechanism that connects and facilitates communication between two or more components, devices, systems, or other entities. A connection mechanism can be or include a relatively simple mechanism, such as a cable or system bus, and/or a relatively complex mechanism, such as a packet-based communication network (e.g., the Internet). In some instances, a connection mechanism can be or include a non-tangible medium, such as in the case where the connection is at least partially wireless. In this disclosure, a connection can be a direct connection or an indirect connection, the latter being a connection that passes through and/or traverses one or more entities, such as a router, switcher, or other network device. Likewise, in this disclosure, a communication (e.g., a transmission or receipt of data) can be a direct or indirect communication.

In some instances, the content system 100 can include multiple instances of at least some of the described components. The content system 100 and/or components thereof can take the form of a computing system, an example of which is described below.

### B. Computing System

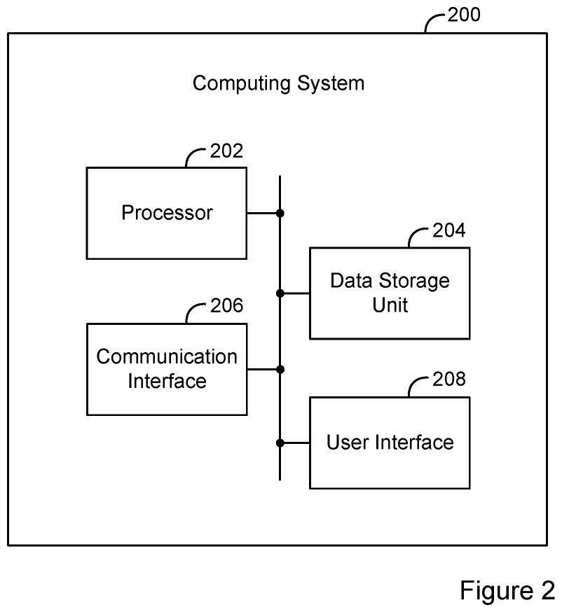

FIG. 2 is a simplified block diagram of an example computing system 200. The computing system 200 can be configured to perform and/or can perform various operations, such as the operations described in this disclosure. The computing system 200 can include various components, such as: a processor 202, a data storage unit 204, a communication interface 206, and/or a user interface 208.

The processor 202 can be, or include, a general-purpose processor (e.g., a microprocessor) and/or a special-purpose processor (e.g., a digital signal processor). The processor 202 can execute program instructions included in the data storage unit 204 as described below.

The data storage unit 204 can be or include one or more volatile, non-volatile, removable, and/or non-removable storage components, such as magnetic, optical, and/or flash storage, and/or can be integrated in whole or in part with the processor 202. Further, the data storage unit 204 can be, or include, a non-transitory computer-readable storage medium, having stored thereon program instructions (e.g., compiled or non-compiled program logic and/or machine code) that, upon execution by the processor 202, cause the computing system 200 and/or another computing system to perform one or more operations, such as the operations described in this disclosure. These program instructions can define, and/or be part of, a discrete software application.

In some instances, the computing system 200 can execute program instructions in response to receiving an input, such as an input received via the communication interface 206 and/or the user interface 208. The data storage unit 204 can also store other data, such as any of the data described in this disclosure.

The communication interface 206 can allow the computing system 200 to connect with and/or communicate with another entity according to one or more protocols. Therefore, the computing system 200 can transmit data to, and/or receive data from, one or more other entities according to one or more protocols. In one example, the communication interface 206 can be or include a wired interface, such as an Ethernet interface or a High-Definition Multimedia Interface (HDMI). In another example, the communication interface 206 can be or include a wireless interface, such as a cellular or Wi-Fi interface.

The user interface 208 can allow for interaction between the computing system 200 and a user of the computing system 200. As such, the user interface 208 can be or include an input component such as: a keyboard, a mouse, a remote controller, a microphone, and/or a touch-sensitive panel. The user interface 208 can also be or include an output component such as a display screen (which, for example, can be combined with a touch-sensitive panel), one or more projectors (e.g., for projecting supplemental video content, as described in greater detail below), and/or a sound speaker. The display screen can have a display area (where video content can be displayed), and that display area can have an aspect ratio.

The computing system 200 can also include one or more connection mechanisms that connect various components within the computing system 200. For example, the computing system 200 can include the connection mechanisms represented by lines that connect components of the computing system 200, as shown in FIG. 2.

The computing system 200 can include one or more of the above-described components and can be configured or arranged in various ways. For example, the computing system 200 can be configured as a server and/or a client (or perhaps a cluster of servers and/or a cluster of clients) operating in one or more server-client type arrangements, such as a partially or fully cloud-based arrangement, for instance.

As noted above, the content system 100 and/or components of the content system 100 can take the form of a computing system, such as the computing system 200. In some cases, some or all of these entities can take the form of a more specific type of computing system, such as: a desktop or workstation computer, a laptop, a tablet, a mobile phone, a television, a set-top box, a streaming media device, and/or a head-mountable display device (e.g., virtual-reality headset or an augmented-reality headset), among numerous other possibilities.

### III. Example Operations

The content system 100, the computing system 200, and/or components of either can be configured to perform and/or can perform various operations. As noted above, the content system 100 can perform operations related to media content. But the content system 100 can also perform other operations. Various example operations that the content system 100 can perform, and related features, will now be described with reference to select figures.

In one aspect, the content manager 102 can obtain video content from the content database 104 and can determine an aspect ratio of the video content. The content manager 102 can determine the aspect ratio of the video content in various ways. For example, this can involve the content manager 102 obtaining metadata associated with the video content, where the obtained metadata specifies a resolution of the video content, and then using the specified resolution of the obtained metadata to determine the aspect ratio of the video content. As one example, the content manager 102 can use the specified resolution to determine an aspect ratio by diving the resolution width by the resolution height. For instance, in the case of the resolution 640×480, the content manager 102 can divide 640 by 480 to arrive at an aspect ratio of 1.333 (repeating):1, which can also be expressed in other ways, such as 4:3.

Next, the content manager 102 can determine a target aspect ratio. The content manager 102 can determine the target aspect ratio in various ways. For example, the content manager 102 can determine the target aspect ratio by looking it up in a database. In practice, one or more common aspect ratios could be recorded in a database, to indicate that those are common aspect ratios of display areas of display screens, which may serve as the basis for the content manager 102 generating supplemental video content for use in connection with the displaying the video content on a content-presentation device having a display area with a given one or more of those common aspect ratios.

In other examples, though, the content manager 102 can prepare to generate supplemental video content for display by a specific content-presentation device (e.g., the content-presentation device 108) having a display area with a specific aspect ratio. Accordingly, in one example, determining the target aspect ratio can involve determining as aspect ratio of the display area of the content-presentation device 108. The content manager 102 can to this in various ways, such as by accessing a hardware specification profile of the content-presentation device 108, for instance.

Notably, the target aspect ratio can be different from the aspect ratio of the video content. For example, in the case where the aspect ratio of the video content is 4:3, the target aspect ratio can be 16:9, or vice versa.

Next, the content manager 102 can determine an aspect ratio and position of at least one empty video content region that results from inserting the video content having the aspect ratio (though as a scaled-down resolution version) into a frame having the target aspect ratio. For the purpose of providing an example, it can be assumed that in this scenario, the inserting involves centering the video content within the frame.

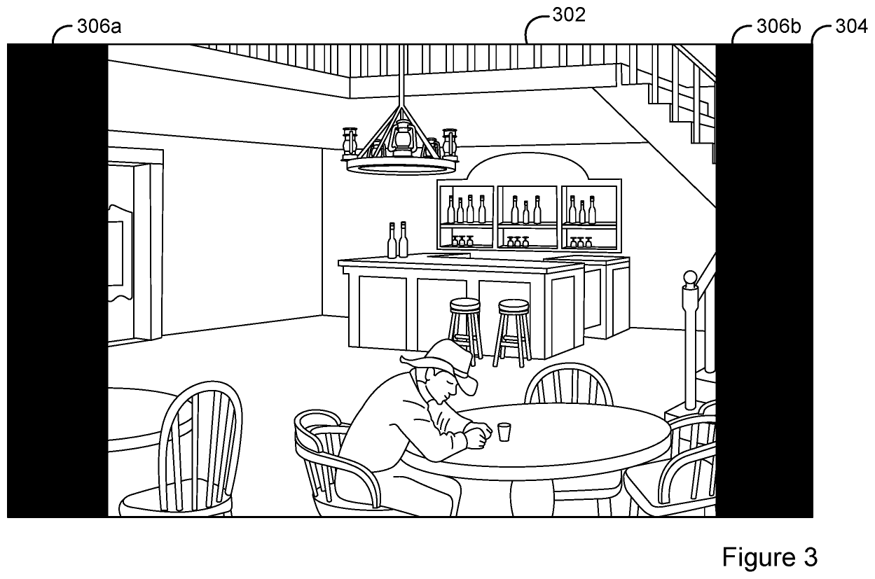

FIG. 3 helps illustrate this determining operation in the context of an example in which video content 302 having a 4:3 aspect ratio is inserted (and centered within) a frame 304 that has a 16:9 aspect ratio. As shown, this inserting results in two vertical-side-longer rectangular empty video content regions 306a, 306b, each positioned at an opposite horizontal end of the frame 304. Specifically, the first empty video content region 306a is positioned at a left end of the frame 304, and the second empty video content region 306b is positioned at a right end of the frame 304.

Each of the empty video content regions 306a, 306b has a respective aspect ratio and position (within the frame 304), which the content manager 102 can determine in various ways, such as by subtracting the video content 302 from the frame 304. Thus, for the example shown in FIG. 3, the content manager 102 can determine that the empty video content regions 306a, 306b each have an aspect ratio of 2:9 and are positioned at the left end and right ends, respectively, of the frame 304.

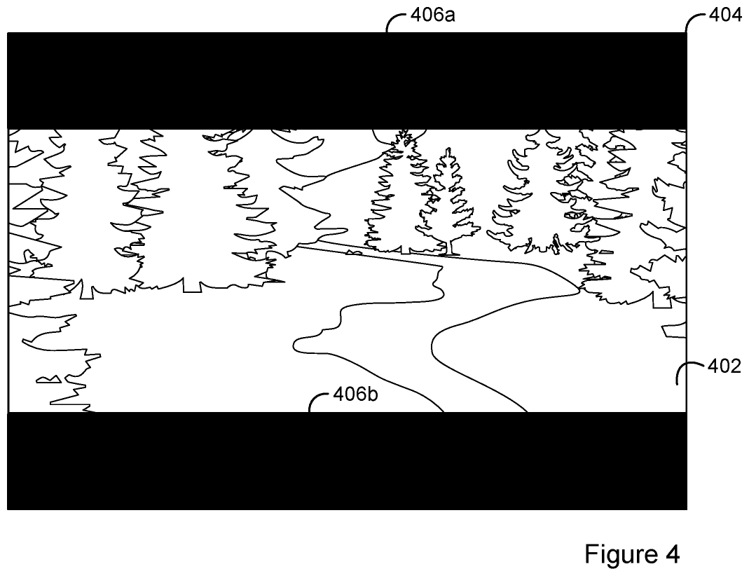

FIG. 4 helps illustrate this determining operation in the context of another example in which video content 402 that has a 16:9 aspect ratio is inserted (and centered within) a frame 404 that has a 4:3 aspect ratio. As shown, this inserting results in two horizontal-side-longer rectangular empty video content regions 406a, 406b, each positioned at an opposite vertical end of the frame. Specifically, the first empty video content region 406a is positioned at the upper end of the frame 404, and the second empty video content region 406b is positioned at the lower end of the frame 404.

As with the previous example related to FIG. 3, with this example related to FIG. 4, each of the empty video content regions 406a, 406b has a respective aspect ratio and position (within the frame 404), which the content manager 102 can determine in various ways, such as by subtracting the video content 402 from the frame 404. Thus, for the example shown in FIG. 4, the content manager 102 can determine that the empty video content regions 406a, 406b each have an aspect ratio of 32:3 and are positioned at the upper end and lower end, respectively, of the frame 404.

In different situations involving different aspect ratios of video content and/or different target aspect ratios, the aspect ratio and/or position of the at least one empty video content region can vary. Indeed, many other examples are possible depending on different aspect ratios of video content and/or different target aspect ratios, and/or depending on where the video content is positioned (by being centered or by being positioned in a different way) with the corresponding frame.

The content manager 102 can then use at least a portion of the video content to generate corresponding supplemental video content that is suitable for insertion into the at least one empty video content region having the corresponding determined aspect ratio and position. As such, such in the context of the example discussion in connection with FIG. 3, the content manager 102 can generate supplemental video content to be inserted into the empty video content regions 306a, 306b, and in the context of the example discussion in connection with FIG. 4, the content manager 102 can generate supplemental video content to be inserted into the empty video content regions 406a, 406b.

The content manager 102 can use various data to generate supplemental video content that is contextually relevant to the video content and/or that is personalized for the specific user of the content-presentation device 108. In various examples, the content manager 102 can use (i) a least a portion of video content, (ii) the determined aspect ratio and/or position of the at least one empty video content region, (iii) metadata associated with the video content, and/or (iv) user profile data associated with a user of the content-presentation device 108, to generate supplemental video content and/or other output data. As will be discussed in greater detail below, the content manager 102 can then perform one or more actions to facilitate the content-presentation device 108 displaying in a display area having the target aspect ratio, both the video content and the supplemental video content. In some instances, the supplemental video content can be a single supplemental video content item, but in other examples, the supplemental video content can include multiple supplemental video content items. For example, the supplemental video content can include two supplemental video content items, to be inserted into a respective one of two different empty video content regions, such as in the examples discussed above.

The content manager 102 can use the above-described or other types of data to generate supplemental video in various ways. For example, the content manager 102 can do so by employing a machine learning technique, such as one that uses a video content generation model that has been trained using a deep neural network (DNN). The model can use an input data set to generate supplemental video content and/or other data that is part of an output data set.

The input data set can include various types of data. For example, the input data set can include (i) a least a portion of video content, (ii) the determined aspect ratio and/or the determined position of the at least one empty video content region, (iii) metadata associated with the video content, and/or (iv) user profile data associated with a user of the content-presentation device 108.

As noted above, the input data set can include at least a portion of video content, and thus can be one or more frames of video content. As such, this can include the video content for which corresponding supplemental video content is to be generated for, or a portion thereof. Additionally or alternatively, this video content can be video content that precedes or follows the video content for which corresponding supplemental video content is to be generated for.

In some examples, the content manager 102 can provide the video content to a scene identification system (which can employ any scene identification technique now known or later discovered) that can analyze video content and responsively provide an indication as to the starting and ending points of any scenes within the video content. This can allow the content manager 102 to provide, as part of the input data set, a portion of the video content that represents a given scene. Among other things, this can help ensure that the model generated corresponding supplemental video content that takes into account the entire scene temporally, and thus can generate supplemental video content corresponding to that entire scene. Among other things, this can help the model generate more consistent and/or contextually relevant supplemental video content.

Within this context, in one example related to FIG. 3, the content manager 102 can provide to the model, as part of an input data set, some or all of the video content 302. Or in another example related to FIG. 4, the content manager 102 can provide to the model, as part of an input data set, some or all of the video content 402.

Additionally or alternatively, the input data set can include the determined aspect ratio and/or the determined position of the at least one empty video content region. This can help ensure that the model generates supplemental video content of an appropriate aspect ratio, to fit the at least one empty video content region, and that accounts for the intended position of the supplemental video content.

Within this context, in one example related to FIG. 3, the content manager 102 can provide to the model, as part of the input data set, the determined aspect ratio and position of each of the two empty video content regions 306a, 306b. As such, for the empty video content region 306a, the content manager 102 can provide the aspect ratio 2:9 and the position of the left end of the frame. And for the empty video content region 306b, the content manager 102 can provide the aspect ratio 2:9 and the position of the right end of the frame. Or in another example related to FIG. 4, the content manager 102 can provide to the model, as part of the input data set, the determined aspect ratio and position of each of the two empty video content regions 406a, 406b. As such, for the empty video content region 406a, the content manager 102 can provide the aspect ratio 32:3 and the position of the upper end of the frame. And for the empty video content regions 306b, the content manager 102 can provide the aspect ratio 32:3 and the position of the lower end of the frame.

Additionally or alternatively, the input data set can include metadata associated with the video content. This can help ensure that the model generates supplemental video content that is contextually relevant to the video content. There could be various types of metadata that the content manager 102 can obtain from various sources. For example, the metadata can relate to scene context information.

The content manager 102 can obtain scene context information from the content database 104 or elsewhere, and can do in various ways. For example, for given video content, the content manager 102 can (i) obtain closed-captioning text (e.g., which the content manager 102 can extract from metadata associated with the video content), (ii) subtitle text (e.g., which the content manager 102 can obtain by providing the video content to an optical character recognition (OCR) system and responsively receiving the subtitle text), (iii) dialogue text (e.g., which the content manager 102 can obtain by providing an audio component of the video content to a speech-to-text (STT) system and responsively receiving the dialogue text), (iv) a text description of an object (e.g., which content manager 102 can obtain by providing the video content to an object detection system and responsively receiving the text description of the object), and/or (v) a text description of a segment (e.g., which content manager 102 can obtain by providing the video content to a semantic understanding/description system and responsively receiving the text description of the segment), among numerous other possibilities. For these purposes, the content manager 102 can use any OCR system, STT system, object detection system, and/or semantic understanding/description system, now known or later discovered.

In other examples, the content manager 102 can obtain scene context information, or more generally, video content context information, by extracting it as metadata stored in connection with the video content and/or a portion thereof, or by obtaining it from an external source, such as an online media content database, for example. Such scene context information or video content context information can include or relate to plot or synopsis text, set location information, identifies of associated actors, producers or other relevant parties, camera settings, color profiles or other cinematography-related attributes, an indication of a scene being considered key shots, and/or an indication of a frame being a first or last frame of scene, among numerous other possibilities that might help the model generally contextually relevant and/or user personalized supplemental video content.

Within this context, in one example related to FIG. 3, the content manager 102 can provide to the model, as part of an input data set, text data that describes or otherwise relates to the video content 302 (e.g., text that describes the video content generally as being a Western-style movie, or that describes the given scene as taking place in a saloon, etc.). Or in another example related to FIG. 4, the content manager 102 can provide to the model, as part of an input data set, text that describes or otherwise relates to the video content 402.

Additionally or alternatively, the input data set can include profile data associated with a user of the content-presentation device 108. This can help ensure that the model generates supplemental video content that is personalized to the user and/or that aligns with one or more targeted advertising goals.

For example, in the case where the content manager 102 determines that user profile data indicates the user has a preference for or interest in a certain actor/actress, this user profile data can help cause the model to generate supplemental video content that depicts or relates to that actor/actress. As noted above, in some examples, the user profile data can include targeted advertisement data. For instance, in the case where the content manager 102 determines that user profile data indicates the user has a preference for a given type of soda, this data can help cause the model to generate supplemental video content that depicts that soda, to further one or more targeted advertising goals.

There can be various types of user profile data that can be obtained/used in this context. For example, the user profile data can include demographic data that provides details about the user's age, gender, etc. As another example, the user profile data can include preference data that indicates content-related preferences for that user. For example, the preference data could include genre preference data that indicates one or more genre types (e.g., action, adventure, comedy, or romance) that the user prefers. As another example, as noted above, the preference data could include actor/actress preference data that indicates one or more actors or actresses that the user prefers. There can be many other types of preference data as well, including preference data related to any aspect of media (e.g., preferences related to plot types, writers, directors, settings, art styles, release dates, budgets, ratings, and/or reviews, among numbers possibilities).

Preference data can be represented in various ways. For instance, preference data can be represented with one or more scores (e.g., from 0-100) being assigned to each of multiple different potential preferences to indicate a degree or confidence score of each one, with 0 being the lowest and 100 being the highest, as just one example. For instance, in the case where the preference data indicates genre type preferences, the preference data could indicate a score of 96 for action, a score of 82 for adventure, a score of 3 for comedy, a score of 18 for romance, and so on. As such, the score of 96 for action can indicate that the user generally has a strong preference for media content of the action genre. Similarly, the score of 82 for adventure can indicate that the user also generally has a strong preference for media content of the adventure genre, though not quite as strong as a preference as compared to the action genre. And so on for each of the other genres.

There can be other types of user profile data as well. For example, user profile data can include content presentation history information of the user, among numerous other possibilities. In some instances, content presentation history information could indicate various user activity in connection with media content and/or portions thereof. For example, user profile data could indicate which movies, television shows, or advertisements a user has watched, how often, etc. In another example, user profile data could indicate an extent to which the user has replayed or paused certain media, or a segment thereof, which might indicate a certain level of interest in that portion. In another example, user profile data can include an emotional response profile for that user.

In another example, user profile data can include annotations made by the user in connection with a given segment of media content. In one aspect, while a user is viewing media content via the content-presentation device 108, the user can use a user interface of the content-presentation device 108 to annotate the media content, such as by marking a specific temporal portion of the media content (e.g., with starting frame and ending frame markers) or by adding corresponding notes (e.g., by entering text, adding a voice-based note, etc.). This annotation data can then be stored as metadata and later obtained for use in connection with the techniques described herein and/or for various other purposes.

Such user profile data can be obtained, stored, organized, and retrieved in various ways, such as by using any related user profile data technique now known or later discovered. In some instances, user profile data can be obtained, stored, and/or used only after the user has provided explicit permission for such operations to be performed. Likewise, in some cases, various other features and/or operations disclosed herein can be provided/performed only after the user has provided explicit permission to do so. Notably, user profile data can also be used to store user settings for various configurations (e.g., to enable or disable one or more features, such as those disclosed herein).

Additionally or alternatively, the input data set can include still other types of data, such as previous output data sets of previous iterations of using the model (in connection with other portions of the video content, or for related video content). This can help ensure that the model generates output that is consistent with previously generated output. In practice this can help ensure that there is consistency among supplemental video content generated over a given time period, such as in connection with a given segment of video content.

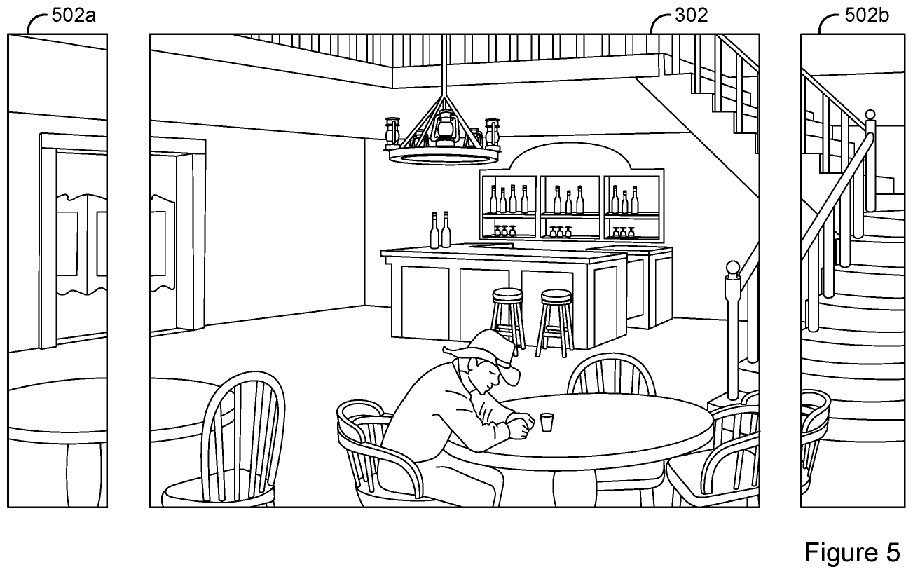

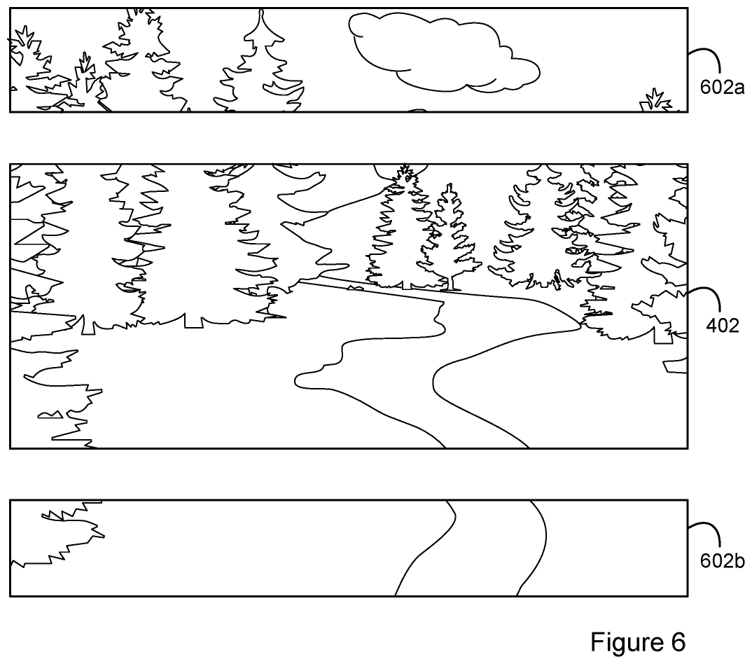

Turning now to the output data set, this can include corresponding supplemental video content and/or other output data. Within this context, in one example related to FIG. 3, the content manager 102 can generate supplemental video content that is suitable to be inserted into the empty video content regions 306a, 306b. For example, as shown in FIG. 5, the content manager 102 can generate two supplemental video content items, namely supplemental video content 502a and supplemental video content 502b. For context, FIG. 5 also shows the video content 302 that the supplemental video content 502a, 502b corresponds to. In another example related to FIG. 4, the content manager 102 can generate supplemental video content that is suitable to be inserted into the empty video content regions 406a, 406b. For example, as shown in FIG. 6, the content manager 102 can generate two supplemental video content items, namely supplemental video content 602a and supplemental video content 602b. For context, FIG. 6 also shows the video content 402 that the supplemental video content 602a, 602b corresponds to.

In some cases, the model can also provide other output data, such as metadata for the generated supplemental video content (e.g., data indicating or relating to resolution, aspect ratio, intended position, etc.). Thus, in some examples, the content manager 102 using at least a portion of the video content to generate corresponding supplemental video content can involve the content manager 102 (i) providing to a trained model, at least a portion of the video content; and (ii) responsively receiving from the trained model, corresponding supplemental video content, wherein the trained model used at least the portion of the video content to generate the corresponding supplemental video content.

Various different types of models could be used for this purpose, including for example, any video content generation model now known or later developed. Regardless of the employed model, before the content manager 102 uses a model for this purpose, the content system 100 can first train the model by providing it with training input data sets and training output data sets that parallel those input and output data sets discussed above in connection with the runtime phase, but in a training phase. As such, the model can be trained in a training phase and then the trained model can be used in a runtime phase, such as in the ways discussed above.

In practice, it is likely that large amounts of training data-perhaps thousands of training data sets or more-would be used to train the model, as this generally helps improve the usefulness of the model. Training data can be generated in various ways, including by being manually assembled. However, in some cases, the one or more tools or techniques, including any training data gathering or organization techniques now known or later discovered, can be used to help automate or at least partially automate the process of assembling training data and/or training the model. For these purposes, the content manager 102 can use any machine learning technique, DNN, and/or model now known or later discovered.

In some cases, existing images and/or video content, with certain editing, can be used as at least part of the training data. For example, the content manager 102 can obtain video content having a 16:9 aspect ratio. The content manager 102 can then generate an edited version of the video content by redacting/removing certain portions (e.g., black bar portions, such as those shown in FIG. 3), such that the edited video content has a 4:3 aspect ratio. The content manager 102 can then train a model by providing it with the edited 4:3 aspect ratio video content as training input data (perhaps along with other input data, such as the various types described above), together with the 16:9 video content as training output data. In this way, the content manager 102 can train the model to start with the 4:3 aspect ratio content, and learn how to generate corresponding supplemental video content.

After the supplemental video content is generated, the content manager 102 can then perform one or more actions to facilitate the content-presentation device 108 displaying in a display area (of the content-presentation device 108) having the target aspect ratio, both the video content and the supplemental video content. In one example, this displaying involves (i) centering the video content within the display area, and (ii) positioning the generated supplemental video content within the at least one empty video content region that results from displaying the video content having the aspect ratio within the display area having the target aspect ratio.

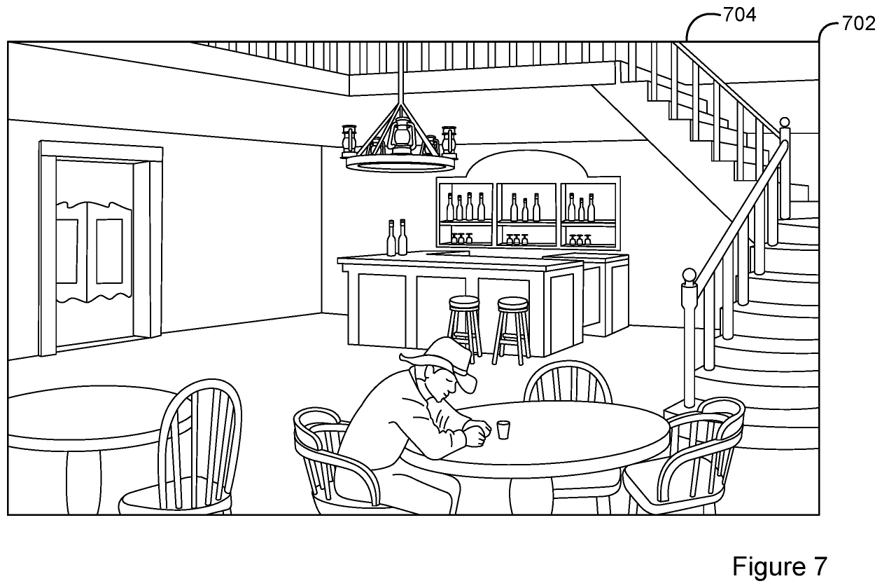

With this context, in one example related to FIG. 5, the content manager 102 can center the video content 302 within the display area and can position the generated supplemental video content 502a, 502b within the at least one empty video content region that results from displaying the video content having the aspect ratio within the display area having the target aspect ratio. The result is composite video content that fills the entire display area. FIG. 7 shows an example of this. As shown, the composite video content 704 is displayed in the display area 702.

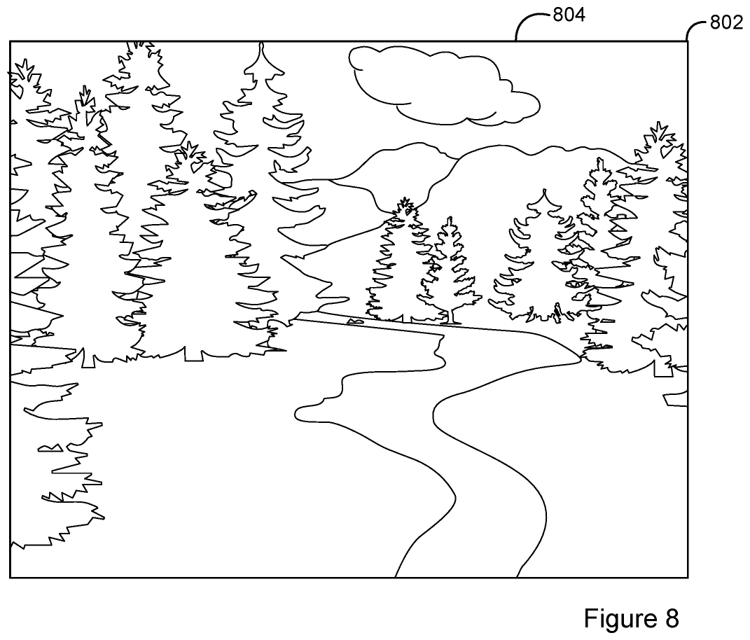

As another example, related to FIG. 6, the content manager 102 can center the video content 402 within the display area and can position the generated supplemental video content 602a, 602b within the at least one empty video content region that results from displaying the video content having the aspect ratio within the display area having the target aspect ratio. The result is composite video content that fills the entire display area (or at least an increased portion of it). FIG. 8 shows an example of this. As shown, the composite video content 804 is displayed in the display area 802.

In various examples, the content manager 102 performing the one or more actions to facilitate the content-presentation device 108 displaying in a display area having the target aspect ratio, both the video content and the supplemental video content, involves generating the composite video and causing transmitting (e.g., by leveraging the content-distribution system 106) the generated composite video content to the content-presentation device 108 for display in a display area of a display screen. The content-presentation device 108 can then receive and display the composite video content.

As noted above, in some examples, in the context of determining an aspect ratio and position of at least one empty video content region that results from inserting the video content having the aspect ratio into a frame having the target aspect ratio, the inserting can involve centering the video content within the frame. And similarly, in the context of performing one or more actions to facilitate a content-presentation device displaying in a display area having the target aspect ratio, both the video content and the supplemental video content, the displaying can involve centering the video content within the display area.

However, in other examples, the inserting can involve inserting video content within a different region (other than a centered region) of the frame. Likewise, the displaying can involve displaying the video content within a different region (other than a centered region) of the display area. Indeed, in some examples, these regions could be centered regions, but that have been partially or fully shifted left, right, up, or down, as appropriate to suit a desired configuration. As such, the regions could be considered partially or fully left-aligned, right-aligned, top-alighted, or bottom aligned.

This could be useful in various situations. For example, consider a segment of video content that is a scene including characters on the left side of the scene and a room on the right side of the scene. In this scenario, rather than the applicable region being centered, which results in the content manager 102 needing to generate supplemental video content for the left side (e.g., that could include/extend the characters), and supplemental video content for the right side (e.g., that could include/extend the room), the content manager 102 might achieve better results for users by “shifting” the region all the way to the left of the frame/display area, such that the content manager 102 does not need to generate supplemental video content for a left side, but instead can just generate (twice as much) supplemental video content for a right side, as this may be a relatively easier type of video content (e.g., where the subject of the supplemental video content is a room as compared to characters) for the content manager 102 to generate. Of course, this is just one example illustration of a situation where the referenced regions are not centered. In practice, such regions could be positioned differently.

In these or other examples, the content manager 102 can use one or more types of data from the input data set described above, and/or other data, to determine/set the position of the region, what supplemental video content to generate in view that position, etc. Among other things, such data can include data derived from future frames, camera changes, data about characters in the frame, lighting, etc., among numerous types of data that might be considered to achieve desirable results that are pleasing to users and/or that have other desirable characteristics.

Although various examples have been described herein in which the content manager 102 performs certain operations (i.e., in a server-side type arrangement), in other examples, one or more other systems or devices, could perform such operations instead. For example, the content-presentation device 108 could perform such operations or other operations as appropriate (in a client-side type arrangement).

For example, in the case where the content-presentation device 108 performs the one or more actions to facilitate the content-presentation device 108 displaying in a display area having the target aspect ratio, both the video content and the supplemental video content, this can involve the content-presentation device 108 generating the composite video content and displaying the generated composite video content.

In some examples, such as in the case where the some or all of the operations are performed by the content-presentation device 108, the content-presentation device 108 can be configured with a content buffer, such that the content-presentation device 108 can have a delay (e.g., 1-3 seconds) between the time point at which it receives a given portion of video content and a time point at which it displays that portion of the video content. Among other things, this can provide the content-presentation device 108 with sufficient time to perform one or more operations, such as those related to generating supplemental video content, before displaying the generated content.

In other example implementations, there could be a combination of server-side and client-side operations. As such, a server-side device could perform some operations, whereas the client-side device performs other operations. In some instances, the server-side device can perform operations and can store as metadata associated with the video content, data indicating the result of those operations, which the client-side device can receive and use in connection with performing client-side operations.

In another aspect of the disclosure, the content manager 102 can perform some or all of the operations described above, except that instead of generating supplemental video content and inserting it into the empty video content regions, the content manager 102 can instead separate the obtained video content into multiple layers, including a first layer and a second layer; stretch the second layer of the video content to extend into the at least one empty video content region having the corresponding determined aspect ratio and position; and perform one or more actions to facilitate the content-presentation device 108 displaying in a display area having the target aspect ratio, both the first layer of video content and the stretched second layer of video content, such that the combination of the first layer and the stretched second layer of video content fill the display area having the target aspect ratio.

In one example implementation, the first layer can be a background layer and the second layer can be a foreground layer. The result is that the background layer (which may be more likely to include content that can be stretched without having a jarring effect, or at least a minimal one) can be stretched, whereas the foreground layer (which may have content such as character's faces that cannot be stretched without having a jarring effect), can be left as is. As such, the video content can be modified to fill the display area, but modified in a way that is unlikely to be jarring to the user. In connection with separating the content into multiple layers, the content manager 102 can use any layer editing/identification technique now known or later discovered.

As such, in one aspect, the content manager 102 can perform operations including (i) obtaining video content; (ii) separating the obtained video content into multiple layers, including a first layer and a second layer; (iii) determining an aspect ratio of video content; (iv) determining a target aspect ratio, wherein the target aspect ratio is different from the aspect ratio of the video content; (v) determining an aspect ratio and position of at least one empty video content region that results from inserting the video content having the aspect ratio into a frame having the target aspect ratio, wherein the inserting involves centering the video content within the frame; (vi) stretching the second layer of the video content to extend into the at least one empty video content region having the corresponding determined aspect ratio and position; and (vii) performing one or more actions to facilitate a content-presentation device displaying in a display area having the target aspect ratio, both the first layer of video content and the stretched second layer of video content, such that the combination of the first layer and the stretched second layer of video content fill the display area having the target aspect ratio.

In another aspect of the disclosure, the content-presentation device 108 can generate supplemental content using or more of the techniques described herein and can include one or more video content projectors (e.g., pico projectors), which can be configured to output supplemental video content to be displayed on a wall or other surface near the content-presentation device 108, in sync with displaying the corresponding video content on the display area of the content-presentation device 108. In this way, the content-presentation device 108 can provide users with a more immersive experience, in which the video content is “extended” onto surround walls or other surfaces.

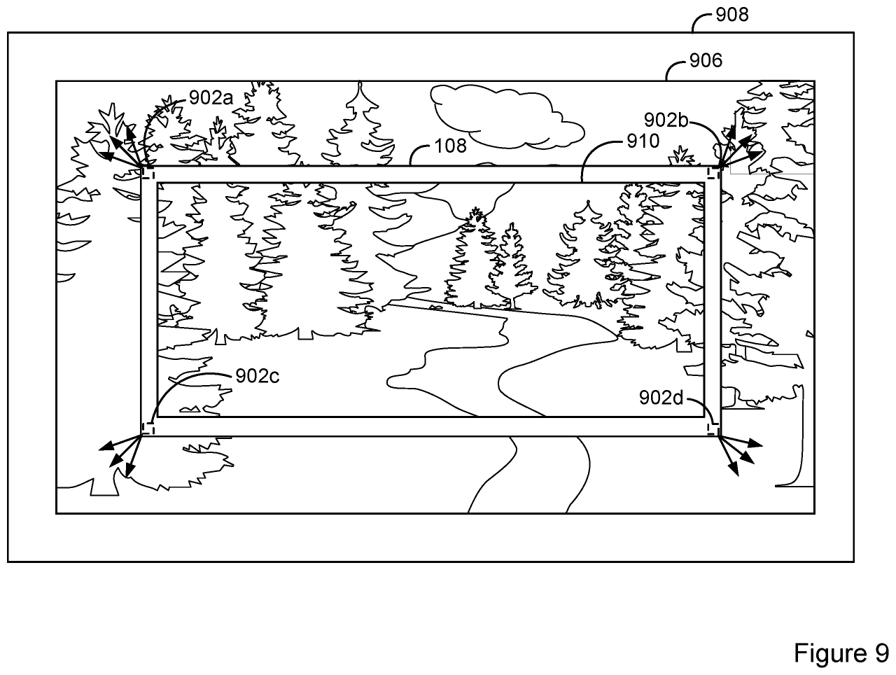

In various examples, the content-presentation device 108 can include various numbers and/or types of projectors, and they can be positioned and/or oriented in various ways. For example, as shown in FIG. 9, the content-presentation device 108 can have four video content projectors 904a, 904b, 904c, and 904d, each positioned near a corner of, and on a back panel of, the content-presentation device 108. Each projector can be positioned and oriented such that it can project supplemental video content 906 onto a nearby wall surface 908 (as indicated with the four sets of three lines and arrows). The projected supplemental video content 906 can thus be displayed in sync together with video content 910 being displayed in a display area of the content-presentation device 108. In various examples, the supplemental video content can be divided into separate portions, such that each projector can project an appropriate portion onto the wall surface 908.

As such, in one aspect, the content-presentation device 108 can perform operations including (i) obtaining video content; (ii) obtaining supplemental video content that relates to the obtained video content; (iii) displaying in a display area of a content-presentation device, the obtained video content; and (iv) in sync with displaying in the display area of the content-presentation device, the obtained video content, projecting, via one or more video content projectors integrated within the content-presentation device, the obtained supplemental video content onto one or more surfaces proximate the content-presentation device.

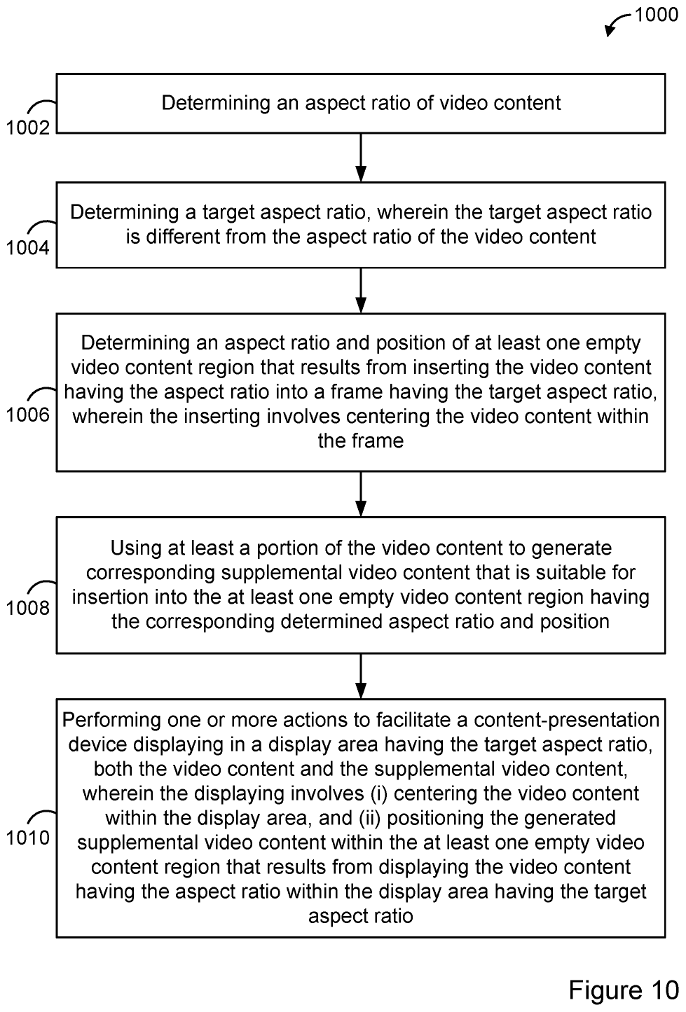

FIG. 10 is a flow chart illustrating an example method 1000. The method 1000 can be carried out by a content manager, such as the content manager 102, a content-presentation device, such as the content-presentation device 108, or more generally, by a computing system, such as the computing system 200. At block 1002, the method 1000 includes determining an aspect ratio of video content. At block 1004, the method 1000 includes determining a target aspect ratio, wherein the target aspect ratio is different from the aspect ratio of the video content. At block 1006, the method 1000 includes determining an aspect ratio and position of at least one empty video content region that results from inserting the video content having the aspect ratio into a frame having the target aspect ratio, wherein the inserting involves centering the video content within the frame. At block 1008, the method 1000 includes using at least a portion of the video content to generate corresponding supplemental video content that is suitable for insertion into the at least one empty video content region having the corresponding determined aspect ratio and position. At block 1010, the method 1000 includes performing one or more actions to facilitate a content-presentation device displaying in a display area having the target aspect ratio, both the video content and the supplemental video content, wherein the displaying involves (i) centering the video content within the display area, and (ii) positioning the generated supplemental video content within the at least one empty video content region that results from displaying the video content having the aspect ratio within the display area having the target aspect ratio.

In some examples, determining the aspect ratio of the video content comprises: obtaining metadata associated with the video content, wherein the obtained metadata specifies a resolution of the video content; and using the specified resolution of the obtained metadata to determine the aspect ratio of the video content.

In some examples, determining the target aspect ratio comprises: determining an aspect ratio of the display area of the content-presentation device.

In some examples, determining an aspect ratio and position of the at least one empty video content region that results from inserting the video content having the aspect ratio into a frame having the target aspect ratio comprises determining an aspect ratio and position of each of two empty video content regions that result from inserting the video content having the aspect ratio into a frame having the target aspect ratio, wherein the two empty video content regions are (i) two vertical-side-longer rectangular empty video content regions, each positioned at an opposite horizontal end of the frame, or (ii) two horizontal-side-longer rectangular empty video content regions, each positioned at an opposite vertical end of the frame.

In some examples, using at least a portion of the video content to generate corresponding supplemental video content that is suitable for insertion into the at least one empty video content region having the corresponding determined aspect ratio and position comprises using at least (i) a portion of the video content and (ii) the determined aspect ratio and position of the at least one empty video content region, to generate corresponding supplemental video content that is suitable for insertion into the at least one empty video content region having the corresponding determined aspect ratio and position.

In some examples, using at least a portion of the video content to generate corresponding supplemental video content that is suitable for insertion into the at least one empty video content region having the corresponding determined aspect ratio and position comprises using at least (i) a portion of the video content and (ii) metadata associated with the video content, to generate corresponding supplemental video content that is suitable for insertion into the at least one empty video content region having the corresponding determined aspect ratio and position.

In some examples, the metadata relates to scene context information or includes text associated with the video content or audio data associated with the video content.

In some examples, using at least a portion of the video content to generate corresponding supplemental video content that is suitable for insertion into the at least one empty video content region having the corresponding determined aspect ratio and position comprises using at least (i) a portion of the video content and (ii) user profile data associated with a user of the content-presentation device, to generate corresponding supplemental video content that is suitable for insertion into the at least one empty video content region having the corresponding determined aspect ratio and position.

In some examples, using at least a portion of the video content to generate corresponding supplemental video content that is suitable for insertion into the at least one empty video content region having the corresponding determined aspect ratio and position comprises using at least (i) a portion of the video content and (ii) targeted advertising data, to generate corresponding supplemental video content that is suitable for insertion into the at least one empty video content region having the corresponding determined aspect ratio and position.

In some examples, using at least a portion of the video content to generate corresponding supplemental video content that is suitable for insertion into the at least one empty video content region having the corresponding determined aspect ratio and position comprises: providing to a trained model, at least a portion of the video content; and responsively receiving from the trained model, corresponding supplemental video content, wherein the trained model used at least the portion of the video content to generate the corresponding supplemental video content.

In some examples, the providing to a trained model, at least a portion of the video content comprises providing to a trained model, at least a portion of the video content together with at least (i) the determined aspect ratio and position of the at least one empty video content region, (ii) metadata associated with the video content, or (iii) user profile data associated with a user of the content-presentation device, together with at least (i) the determined aspect ratio and position of the at least one empty video content region, (ii) the metadata associated with the video content, or (iii) the user profile data associated with a user of the content-presentation device.

In some examples, performing the one or more actions to facilitate the content-presentation device displaying in a display area having the target aspect ratio, both the video content and the supplemental video content comprises: generating composite video content that includes the video content centered with the frame and that further includes the generated supplemental video content within the at least one empty video content region that results from displaying the video content having the aspect ratio within the frame having the target aspect ratio; and transmitting the generated composite video content to the content-presentation device for display in the display area.

In some examples, performing the one or more actions to facilitate the content-presentation device displaying in a display area having the target aspect ratio, both the video content and the supplemental video content comprises: generating composite video content that includes the video content centered with the frame and that further includes the generated supplemental video content within the at least one empty video content region that results from displaying the video content having the aspect ratio within the frame having the target aspect ratio; and displaying, in the display area of the content-presentation device, the generated composite video content.

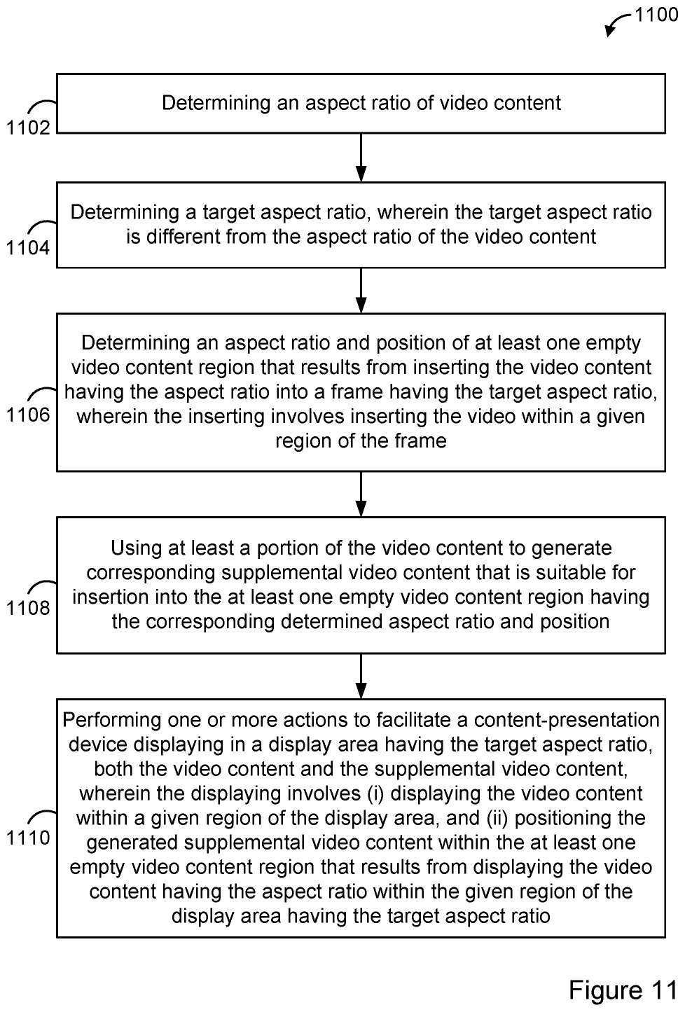

FIG. 11 is a flow chart illustrating an example method 1100. The method 1100 can be carried out by a content manager, such as the content manager 102, a content-presentation device, such as the content-presentation device 108, or more generally, by a computing system, such as the computing system 200. At block 1102, the method 1100 includes determining an aspect ratio of video content. At block 1104, the method 1100 includes determining a target aspect ratio, wherein the target aspect ratio is different from the aspect ratio of the video content. At block 1106, the method 1100 includes determining an aspect ratio and position of at least one empty video content region that results from inserting the video content having the aspect ratio into a frame having the target aspect ratio, wherein the inserting involves inserting the video content within a given region of the frame. At block 1108, the method 1100 includes using at least a portion of the video content to generate corresponding supplemental video content that is suitable for insertion into the at least one empty video content region having the corresponding determined aspect ratio and position. At block 1110, the method 1100 includes performing one or more actions to facilitate a content-presentation device displaying in a display area having the target aspect ratio, both the video content and the supplemental video content, wherein the displaying involves (i) displaying the video content within a given region of the display area, and (ii) positioning the generated supplemental video content within the at least one empty video content region that results from displaying the video content having the aspect ratio within a given region of the display area having the target aspect ratio.

In some examples, some or all of the variations described above in connection with the method 1000 can be applied in connection with the method 1100.

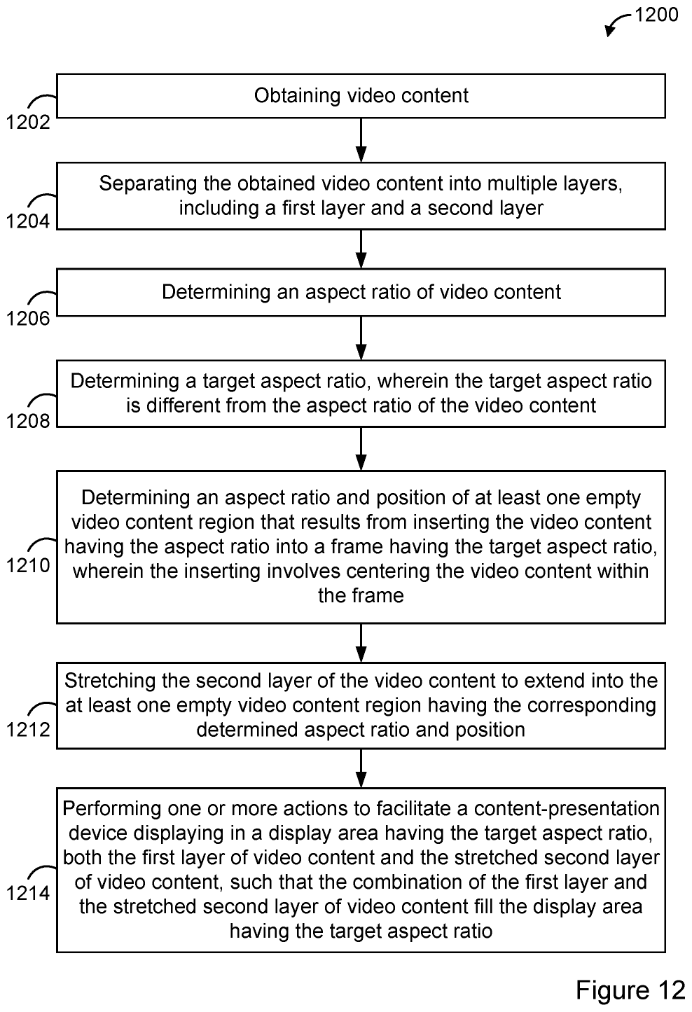

FIG. 12 is a flow chart illustrating an example method 1200. The method 1200 can be carried out by a content manager, such as the content manager 102, a content-presentation device, such as the content-presentation device 108, or more generally, by a computing system, such as the computing system 200. At block 1202, the method 1200 includes obtaining video content. At block 1204, the method 1200 includes separating the obtained video content into multiple layers, including a first layer and a second layer. At block 1206, the method 1200 includes determining an aspect ratio of video content. At block 1208, the method 1200 includes determining a target aspect ratio, wherein the target aspect ratio is different from the aspect ratio of the video content. At block 1210, the method 1200 includes determining an aspect ratio and position of at least one empty video content region that results from inserting the video content having the aspect ratio into a frame having the target aspect ratio, wherein the inserting involves centering the video content within the frame. At block 1212, the method 1200 includes stretching the second layer of the video content to extend into the at least one empty video content region having the corresponding determined aspect ratio and position. At block 1214, the method 1200 includes performing one or more actions to facilitate a content-presentation device displaying in a display area having the target aspect ratio, both the first layer of video content and the stretched second layer of video content, such that the combination of the first layer and the stretched second layer of video content fill the display area having the target aspect ratio.

In some examples, some or all of the variations described above in connection with the method 1000 can be applied in connection with the method 1200.

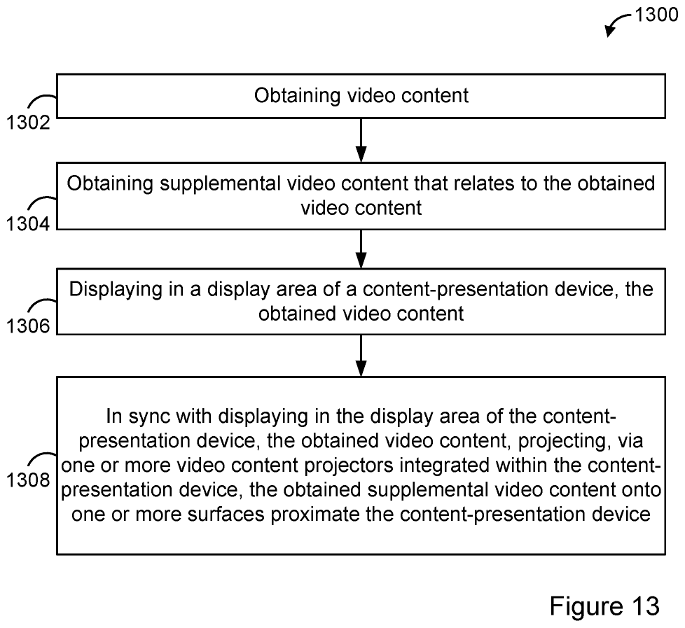

FIG. 13 is a flow chart illustrating an example method 1300. The method 1300 can be carried out by a content manager, such as the content manager 102, a content-presentation device, such as the content-presentation device 108, or more generally, by a computing system, such as the computing system 200. At block 1302, the method 1300 includes obtaining video content. At block 1304, the method 1300 includes obtaining supplemental video content that relates to the obtained video content. At block 1306, the method 1300 includes displaying in a display are of a content-presentation device, the obtained video content. At block 1308, the method 1300 includes in sync with displaying in the display area of the content-presentation device, the obtained video content, projecting, via one or more video content projectors integrated within the content-presentation device, the obtained supplemental video content onto one or more surfaces proximate the content-presentation device.

In some examples, some or all of the variations described above in connection with the method 1000 can be applied in connection with the method 1300.

### IV. Example Variations

Although some of the acts and/or functions described in this disclosure have been described as being performed by a particular entity, the acts and/or functions can be performed by any entity, such as those entities described in this disclosure. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

1. A method comprising:
determining an aspect ratio of video content;
determining a target aspect ratio, wherein the target aspect ratio is different from the aspect ratio of the video content;
determining an aspect ratio and position of at least one empty video content region that results from inserting the video content having the aspect ratio into a frame having the target aspect ratio, wherein the inserting involves centering the video content within the frame;
using at least a portion of the video content to generate corresponding supplemental video content that is suitable for insertion into the at least one empty video content region having the corresponding determined aspect ratio and position; and
performing one or more actions to facilitate a content-presentation device displaying in a display area having the target aspect ratio, both the video content and the supplemental video content, wherein the displaying involves (i) centering the video content within the display area, and (ii) positioning the generated supplemental video content within the at least one empty video content region that results from displaying the video content having the aspect ratio within the display area having the target aspect ratio.

2. The method of claim 1, wherein determining the aspect ratio of the video content comprises:
obtaining metadata associated with the video content, wherein the obtained metadata specifies a resolution of the video content; and
using the specified resolution of the obtained metadata to determine the aspect ratio of the video content.

3. The method of claim 1, wherein determining the target aspect ratio comprises:
determining an aspect ratio of the display area of the content-presentation device.

4. The method of claim 1, wherein determining an aspect ratio and position of the at least one empty video content region that results from inserting the video content having the aspect ratio into a frame having the target aspect ratio comprises determining an aspect ratio and position of each of two empty video content regions that result from inserting the video content having the aspect ratio into a frame having the target aspect ratio, wherein the two empty video content regions are (i) two vertical-side-longer rectangular empty video content regions, each positioned at an opposite horizontal end of the frame, or (ii) two horizontal-side-longer rectangular empty video content regions, each positioned at an opposite vertical end of the frame.

5. The method of claim 1, wherein using at least a portion of the video content to generate corresponding supplemental video content that is suitable for insertion into the at least one empty video content region having the corresponding determined aspect ratio and position comprises using at least (i) a portion of the video content and (ii) the determined aspect ratio and position of the at least one empty video content region, to generate corresponding supplemental video content that is suitable for insertion into the at least one empty video content region having the corresponding determined aspect ratio and position.

6. The method of claim 1, wherein using at least a portion of the video content to generate corresponding supplemental video content that is suitable for insertion into the at least one empty video content region having the corresponding determined aspect ratio and position comprises using at least (i) a portion of the video content and (ii) metadata associated with the video content, to generate corresponding supplemental video content that is suitable for insertion into the at least one empty video content region having the corresponding determined aspect ratio and position.

7. The method of claim 6, wherein the metadata relates to scene context information.

8. The method of claim 6, wherein the metadata includes text associated with the video content or audio data associated with the video content.

9. The method of claim 1, wherein using at least a portion of the video content to generate corresponding supplemental video content that is suitable for insertion into the at least one empty video content region having the corresponding determined aspect ratio and position comprises using at least (i) a portion of the video content and (ii) user profile data associated with a user of the content-presentation device, to generate corresponding supplemental video content that is suitable for insertion into the at least one empty video content region having the corresponding determined aspect ratio and position.

10. The method of claim 1, wherein using at least a portion of the video content to generate corresponding supplemental video content that is suitable for insertion into the at least one empty video content region having the corresponding determined aspect ratio and position comprises using at least (i) a portion of the video content and (ii) targeted advertising data, to generate corresponding supplemental video content that is suitable for insertion into the at least one empty video content region having the corresponding determined aspect ratio and position.

11. The method of claim 1, wherein using at least a portion of the video content to generate corresponding supplemental video content that is suitable for insertion into the at least one empty video content region having the corresponding determined aspect ratio and position comprises:
providing to a trained model, at least a portion of the video content; and
responsively receiving from the trained model, corresponding supplemental video content, wherein the trained model used at least the portion of the video content to generate the corresponding supplemental video content.

12. The method of claim 11, wherein the providing to a trained model, at least a portion of the video content comprises providing to a trained model, at least a portion of the video content together with at least (i) the determined aspect ratio and position of the at least one empty video content region, (ii) metadata associated with the video content, or (iii) user profile data associated with a user of the content-presentation device, together with at least (i) the determined aspect ratio and position of the at least one empty video content region, (ii) the metadata associated with the video content, or (iii) the user profile data associated with a user of the content-presentation device.

13. The method of claim 1, wherein performing the one or more actions to facilitate the content-presentation device displaying in a display area having the target aspect ratio, both the video content and the supplemental video content comprises:
generating composite video content that includes the video content centered with the frame and that further includes the generated supplemental video content within the at least one empty video content region that results from displaying the video content having the aspect ratio within the frame having the target aspect ratio; and
transmitting the generated composite video content to the content-presentation device for display in the display area.

14. The method of claim 1, wherein performing the one or more actions to facilitate the content-presentation device displaying in a display area having the target aspect ratio, both the video content and the supplemental video content comprises:
generating composite video content that includes the video content centered with the frame and that further includes the generated supplemental video content within the at least one empty video content region that results from displaying the video content having the aspect ratio within the frame having the target aspect ratio; and
displaying in the display area of the content-presentation device, the generated composite video content.

15. A computing system configured for performing a set of acts comprising:
determining an aspect ratio of video content;
determining a target aspect ratio, wherein the target aspect ratio is different from the aspect ratio of the video content;
determining an aspect ratio and position of at least one empty video content region that results from inserting the video content having the aspect ratio into a frame having the target aspect ratio, wherein the inserting involves centering the video content within the frame;
using at least a portion of the video content to generate corresponding supplemental video content that is suitable for insertion into the at least one empty video content region having the corresponding determined aspect ratio and position; and
performing one or more actions to facilitate a content-presentation device displaying in a display area having the target aspect ratio, both the video content and the supplemental video content, wherein the displaying involves (i) centering the video content within the display area, and (ii) positioning the generated supplemental video content within the at least one empty video content region that results from displaying the video content having the aspect ratio within the display area having the target aspect ratio.

16. The computing system of claim 15, wherein determining the target aspect ratio comprises:
determining an aspect ratio of the display area of the content-presentation device.

17. The computing system of claim 15, wherein determining an aspect ratio and position of the at least one empty video content region that results from inserting the video content having the aspect ratio into a frame having the target aspect ratio comprises determining an aspect ratio and position of each of two empty video content regions that result from inserting the video content having the aspect ratio into a frame having the target aspect ratio, wherein the two empty video content regions are (i) two vertical-side-longer rectangular empty video content regions, each positioned at an opposite horizontal end of the frame, or (ii) two horizontal-side-longer rectangular empty video content regions, each positioned at an opposite vertical end of the frame.

18. The computing system of claim 15, wherein using at least a portion of the video content to generate corresponding supplemental video content that is suitable for insertion into the at least one empty video content region having the corresponding determined aspect ratio and position comprises using at least (i) a portion of the video content and (ii) metadata associated with the video content, to generate corresponding supplemental video content that is suitable for insertion into the at least one empty video content region having the corresponding determined aspect ratio and position.

19. The computing system of claim 18, wherein the metadata relates to scene context information.

20. A non-transitory computer-readable medium having stored thereon program instructions that upon execution by a processor, cause performance of a set of acts comprising:
determining an aspect ratio of video content;
determining a target aspect ratio, wherein the target aspect ratio is different from the aspect ratio of the video content;
determining an aspect ratio and position of at least one empty video content region that results from inserting the video content having the aspect ratio into a frame having the target aspect ratio, wherein the inserting involves centering the video content within the frame;
using at least a portion of the video content to generate corresponding supplemental video content that is suitable for insertion into the at least one empty video content region having the corresponding determined aspect ratio and position; and
performing one or more actions to facilitate a content-presentation device displaying in a display area having the target aspect ratio, both the video content and the supplemental video content, wherein the displaying involves (i) centering the video content within the display area, and (ii) positioning the generated supplemental video content within the at least one empty video content region that results from displaying the video content having the aspect ratio within the display area having the target aspect ratio.
